(19) United States
(12) Patent Application Publication
(10) Pub. No.: US 2003/0034595 A1
(43) Pub. Date: Feb. 20, 2003

(54) Air bearing

(76) Inventor: Franz Josef Wolf, Bad Soden-Salmuenster (DE)

Correspondence Address: SCHIFF HARDIN & WAITE, 6600 SEARS TOWER, 233 S WACKER DR, CHICAGO, IL, 60606-6473, US

(21) Appl. No.: 10/211,408

(22) Filed: Aug. 1, 2002

(30) Foreign Application Priority Data
Aug. 2, 2001 (DE) 101 37 760.6-12

(51) Int. Cl. F16F 5/00

(52) U.S. Cl. 267/122; 267/64.11

(57) ABSTRACT

An air bearing regulated load-dependent for use in automotive engineering is formed by a central plate through which a freely movable, rigid coupling pin passes axially and is rigidly connected to both a support connector member on the support side and a counterplate on the opposite side. An air spring hose ring that can be variably charged with compressed air or gas is arranged between the support connector member and the central plate and an absorber hose ring is inserted on the opposite side of the central plate between the central plate and a counterplate. The two hose ring systems are directly connected to one another via one or more throttle nozzles. The absorber hose ring has a nozzle or a regulating valve that variably opens the absorber hose ring to the ambient air.

### BACKGROUND OF THE INVENTION

The present invention is directed to an air bearing that is specifically designed for employment in motor vehicle manufacture.

An “air bearing” in the sense being employed here is a resilient, damping and insulating bearing whose supporting, resilient, counter-resilient and, potentially, damping elements as well are chambers with elastically deformable walls that are exclusively filled with either air or a corresponding other gas.

These elastically deformable walls are composed of rubber or another elastomer. They can be reinforced or unreinforced. Moreover, they can be either exclusively composed of an integrated resilient wall or adjoin either rigid component parts, usually plates or disks, or be connected so that, in combination with rigid materials, they form chambers which comprise elastically deformable walls in at least one section. Such chambers can thereby be fashioned as supporting or pumping work chambers, as damping shock absorber chambers or as compensation chambers that offer no elastic resistance to a volume change that can be detected or recognized in the spring characteristics of the overall bearing.

What is decisive for building comfortable motor vehicles is the suspension, insulation and damping of the passenger compartment relative to other noise-absorbent and noise-producing assemblies of the motor vehicle, such as, for example, the wheels with the undercarriage or the motor and the gearing, a unit or the drive train. Since the very inception of automotive engineering, the suspension of the individual assemblies of the motor vehicle relative to one another has offered hardly any serious problems. What, in contrast, continues to remain problematical is a comfortable damping of the springs under all travel conditions as well as an effective insulation of unwanted acoustic and non-acoustic oscillations in the resilient bearings.

Extensive investigations have been made in this area in the recent history of automotive engineering that have found a provisional termination with definitely satisfactory results in view of the comfort achieved in the form of electronically, electrically, mechanically or pneumatically drive, hydraulically dampened rubber spring bearings, that are referred to as hydro-bearings. These technical achievements of the comfort bearing, that have only recently been achieved, however, have been overtaken in the meantime by demands made of the motor vehicle that are not even of an automotive engineering nature. These demands of the motor vehicle are with respect to environmental compatibility and take concerns of political science or public policy into consideration.

In view of the environmental protection, even the most comfortable hydro-bearings exhibit the great disadvantage, on the one hand, of not being meaningfully recyclable and, on the other hand, of comprising a rather high mass due to their fundamentally required compact structure. The high mass of these comfort bearings and the fact that every motor vehicle normally comprises three through six such bearings leads to what is a definite significant increase in overall mass or weight of the motor vehicle, which, in turn, leads to a higher fuel consumption and, thus, environmental pollution.

In terms of political science or public policy, comfort bearings are, and remain, demanding and complicated component parts that oppose the political objective of offering economical motor vehicles for building up a densely network infrastructure.

### SUMMARY OF THE INVENTION

Proceeding from the standard prior art and the political-ecological situation to be currently taken into consideration, the invention is based on the technological problem of creating bearings, namely particularly making bearings available to automotive engineering, whose comfort is superior to the use of rubber bumpers and leaf springs, which are recyclable, which are considerably lighter in weight than the traditional comfort bearings and, moreover, which exhibit design principles and design concepts that enable a lowering of the costs of the bearing functionally built into the motor vehicle in a politically relevant dimension compared to the comfort bearings.

This technological problem and object is obtained by a bearing comprising an air bearing, particularly for use in automotive engineering. The bearing comprises an axially central carrier plate, which is either connected as an abutment to a carrying panel or is directly fashioned in the frame of the vehicle by an appropriate deformation or is a load connection member which is arranged freely oscillatable in the bearing, a pair of containing plates fashioned as a support plate on one side of the carrier plate and a counterplate which lies opposite the support plate on the opposite side of the carrier plate, means for axially rigidly connecting the containing plates to one another, at least one elastic spring member between the carrier plate and a support plate, at least one elastic absorber member between the carrier plate and the counterplate being in pneumatic communication with the air spring member, a supply hose for supplying air or another gas to the air spring member and at least one damping nozzle between the air spring member and the absorber member.

Preferably, the absorber member is connected to ambient air or the atmosphere via a control element selected from a throttle nozzle, a control valve or a regulating valve. The supply hose preferably is connected to a controllable or regulated air or gas supply system. The absorber member may be a thin elastic compensation membrane which is not resilient in itself in the application-relevant scope of the bearing characteristics. The absorber member may be a hose ring that is adjusted as a damping counterspring or adjustably matches the respective operating conditions. The air spring member may also be a hose ring spring. Both hose ring springs may have a toroidal configuration. If the air spring member and the absorber member have the toroidal configuration, then the wall profile, in cross-section, is selected to provide anisotropic spring characteristics for the bearing. The air spring member and the absorber member can each be either annular channel-shaped or spherical cap-shaped elastomer profile members having edges which are pneumatically tight in contact with the containing plates and/or the central plate, so as to provide chambers, and these members are connected back-to-back with the convex outer surfaces and are provided with a pneumatic connection between the two members to form an overflow channel, a throttle channel and a regulating valve or control valve. The pneumatic connection of the two pneumatic chambers lying opposite one another on the two surfaces of the carrier plate are directly connected by an opening in the carrier plate.

Other advantages and features of the invention will be readily apparent from the following description, the claims and drawings.

### BRIEF DESCRIPTION OF THE DRAWINGS

FIG. 1 is an axial cross-sectional view of an air-dampened air bearing in accordance with the present invention;

FIG. 2 is an axial cross-sectional view of a modification of the air-dampened air bearing of FIG. 1; and

FIG. 3 is a partial axial cross-sectional view of a second exemplary embodiment of an air bearing with a central load linkage.

### DESCRIPTION OF THE PREFERRED EMBODIMENTS

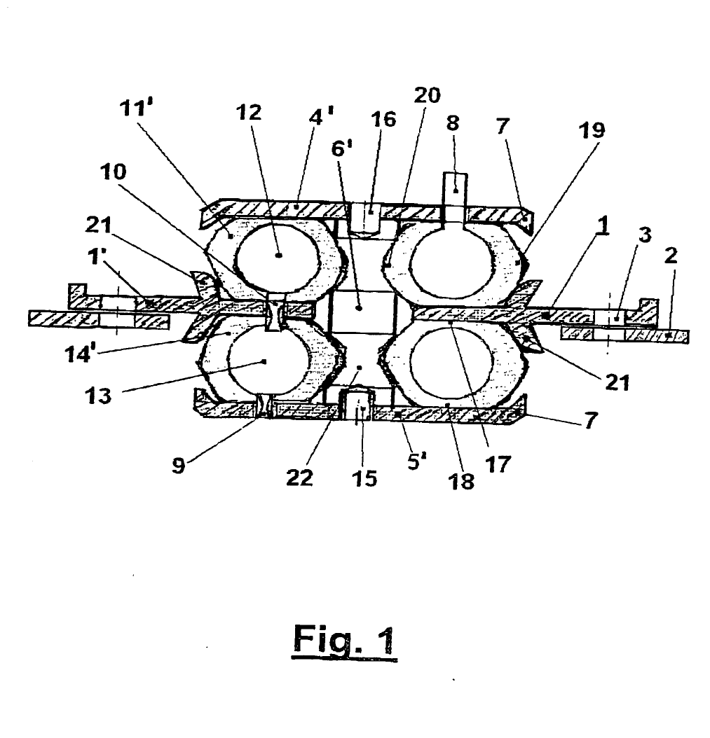

The principles of the present invention are particularly useful when incorporated in an air bearing shown in FIG. 1, which is usable in automotive engineering as a motor bearing or assembly bearing. The air bearing is composed of a carrier plate 1 that is connected as an abutment 1′ to a carrying panel 2, for example a part of the chassis of a car. This connection is formed by means of a stud or bolt arrangement, which is not illustrated in FIG. 1, and extends through drill holes 3.

The bearing also includes a load-side steel disk as a support plate 4′ on one side of the carrier plate 1 and also a corresponding disk as a counterplate 5′ on the opposite side of the carrier plate 1. A central coupling pin 6′ rigidly connects the support plate 4′ and the counterplate 5′ to one another and forms the means for rigidly connecting the two plates together. The support plate and the counterplate are arranged plane-parallel and concentrically relative to one another. Over and above this, these two plates 4 and 5 of the bearing are identically configured bearing parts in the exemplary embodiment shown in FIG. 1. The support plate 4′ and the counterplate 5′ are identical insofar as both are fashioned as punched and drawn-steel plates with a peripherally all-around, canted-off apron or skirt ring 7, a through central opening for the connection of the core pin 6′ and a respective, centrally-fashioned, through opening approximately between the center and the periphery. These two intermediate openings are individualized in that a compressed air supply connection 8 is formed in the punch hole of the steel disk of the support plate 4′, whereas an open throttle nozzle 9 is inserted in the comparable punch hole in the oppositely residing counterplate 5′.

A corresponding throttle nozzle 10 is also inserted in one or a sequence of through punch holes in the plate 1, which holes can be seen in FIG. 1 and lie on at least approximately the same radius as the clearance or opening for the throttle nozzle 9 in the counterplate 5′ or the opening for the supply connection 8 in the support plate 4′, which supply connection extends to a source of compressed gas or air.

In the exemplary embodiment shown in FIG. 1, the throttle nozzles 9 and 10 are of fundamentally the same type; however, they differ in practice on the basis of their dimensioning. The tuning or adjustment of the various nozzles 9 and 10 thereby differs according to the spring and damping behavior to be set for the overall bearing.

An all-around or annular hose ring 11′ that is manufactured of a pressure-resistant, resilient elastomer and has a work chamber 12, is arranged between the support plate 4′ and the carrier plate 1 and around the central coupling pin 6′. A siimlar hose ring 14′ with a chamber 13 is arranged between the plate 5′ and the plate 1. The air pressure supply connection 8 extends into the air spring hose ring 11′ and discharges gas or air into a work chamber 12 of the air spring hose rings 11′ to charge the chamber 12 with compress air. A throttle opening 10, which is arranged in the plate 1 and is exactly adjusted in the sense of a fine tuning according to the criterion of the characteristic data of the bearing prescribed according to the proposed use, provides a constant open connection between the working chamber 12 of a spring and the chamber 13 of the absorber hose element or ring 14′.

In the exemplary embodiment of the air bearing with the features of the invention shown in FIG. 1, the absorber hose ring 14′ is fashioned neither as a compensating chamber nor as an absorber chamber axially variable tension-free, but is fashioned with strong, resilient elastomer walls so that it acts as a dynamically damping counterspring. The throttle nozzle 9 that is always open and appropriately configured and dimensioned connects the absorber annular space 13 of the absorber hose ring 14′ to the ambient air.

The three connections 8, 9 and 10 of the two annular hoses 11′ and 14′ are connected to the hose ring chambers respectively air-tight and pressure-resistant, particularly by being glued or vulcanized on as a material lock-like two-component connection or merely under elastic pre-stress of the hose rings.

The counterplate 5′ is rigidly connected to the coupling pin 6′ via a stud or rivet (not shown) and a correspondingly fashioned blind bore 15. In the same way, the support 4′ is connected via a central blind hole 16 in the pin 6′, which is preferably fashioned as a threaded bush and is connected to the pin 6′ either by direct screwing or by screwing in an intermediate pin that serves for the connection of the load. In practice, for example, the bracket arm of a motor vehicle assembly will, thus, be connected at this location.

When the vehicle is not moving, the non-loaded bearing shown in FIG. 1 is statically loaded. For example, the air spring hose ring 11′ serves as a carrying rubber spring, whereas the absorber hose ring 14′ is loaded as a tensile-stressed rubber spring. Dependent on the wall thickness of the hose rings 11′ and 14′, the air spring hose ring 11′ will be axially compressed and will be radially bulged or bellied out and the absorber hose ring 14′ will be radially contracted and axially elongated. It is thereby ideal when both the hose rings are at least non-positively locked to the three traverse plates 4′, 1 and 5′, for example, in the fashion of a two-component connection or by means of mechanically firm snap-in profile connections.

Since this static load configuration occurs without a compressed air supply, the described configuration with the vehicle at rest thus remains in place and is preserved until the working chamber 12 of the air spring hose ring 11′ is charged with compressed air or gas residing under a pressure via the compressed air supply connection 8 and is thereby axially stretched in such a way that the basic configuration of the air pressure bearing shown in FIG. 1 will then occur.

In an especially simple way, this configuration of the spring hoses enables the employment of identical spring hose rings both for the air spring hose ring as well as for the absorber hose ring.

Alternatively thereto, the rubber hose rings 11′ and 14′ can be employed that are pre-shaped so that the configuration shown in FIG. 1 occurs under the influence of the static load at the connection 16. Before the load is placed on, thus, the air spring hose ring 11′ is pre-shaped vertically elliptically to a greater or lesser extent corresponding to the prescribed static load, and the absorber hose ring 14′ is shaped or pre-shaped horizontally elliptically in cross-section or suitably pre-shaped by means of a combination of both measures. Given application of the static load, for example given immobile application of, for example, a motor bracket arm on the air bearing shown in FIG. 1, the configuration shown in FIG. 1 is obtained after an axially resilient compression of the hose ring 11 and relaxation or restoring of the spring ring 14′.

According to a preferred development of the invention and in the way indicated in FIG. 1, both the air spring hose ring 11′ as well as the absorber hose ring 14′ are a circular torus with a likewise circular interior hose cross-section in an axial section lying in the central axis of the torus under a properly intended static pre-load. In this section, however, both the air spring hose ring as well as the absorber hose ring do not comprise a constant wall thickness. On the contrary, the hose wall thickness in every individual ring segment is configured rotational-symmetrically relative to the central axis of the torus, so that they comprise their smallest value in the axial apex points 17 and 18 lying respectively opposite one another and comprise a maximum thickness in the axial apex points 19 and 20 lying respectively radially opposite one another. The result of this is that, given axial, dynamic loading of the air bearing, the greatest deformation stresses of the air hoses occurs at the seating regions on the support plate, the center plate and the counterplate in the form of a minimal roll-up and roll-off. At the same time, this type of roll deformation represents the least destructive deformation for practically any elastomeric material, particularly given permanent-dynamic deformation. Compared thereto, the bellying deformations of the hose in the radial plane are lowered to a minimum as a result of the reinforcement of the hose wall provided at these portions. This is desirable, since dynamic buckling stress loads and bending loads that occur given dynamic bulging or bellying out involve a considerable load on the elastomeric material which are used.

The air bearing having the features shown in FIG. 1 and explained in greater detail above is also distinguished by a minimal loading of the elastomer, even given dynamic continuous stress, for example by a significant increase of the service life.

In the way that is likewise ultimately clear from FIG. 1, the above-described deformation characteristics of the elastomer hoses can also be improved in addition to the configurative measurement of the radial wall reinforcement in that the radial deformation bulging outward are intercepted by suppressor profiles, such as the flanges or skirts 7 on the plates 4′ and 5′ and skirts 21 on the plate 1 and grooves 22 on the rigid pin 6′.

In order to be able to replace and recycle the bearing shown in FIG. 1, following a malfunction or following the expiration of the intended, maximum duration of use, only a single plate fastening need be undone, namely a bolt engaging into the threaded bore 16 or into the threaded bore 15, in order to separate the rubber parts from the metal parts and replace them with new rubber hoses as required. Based on the design, this rubber-metal separation itself does not represent a problem when the bearing hoses are connected to the plates with material lock.

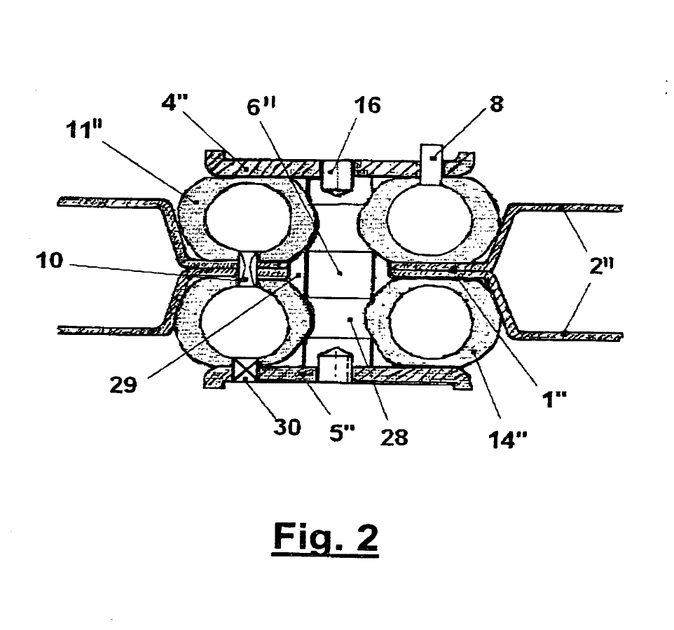

A modification of the development of the invention is shown in FIG. 2. Compared to the exemplary embodiment of the air bearing shown in FIG. 1, the bearing is not separately pre-mounted on a carrier plate 1 and then connected via a pin to the carrying structure of the chassis of the motor vehicle. Instead, the carrier plate 1″ is directly fashioned by deep-drawing structural elements of the chassis carrying structure 2″. The air bearing is, thus, not separately pre-fabricated and connected to the chassis by pinning the flanges. The bearing is built into the vehicle and integrated in the chassis structure in such a way that the counterplate 5″ with the central pin 6″ and the absorber hose 14″, as well as the nozzle 10, are first pre-mounted as a unit in a pin channel 28. This structural unit is then plugged through a punched opening in the pre-formed carrier plate 1″ of the vehicle chassis. Then, from the opposite side, the likewise pre-fabricated assembly composed of the support plate 4″ and the air spring hose 11″ with the air supply connection 8 is then plugged onto the central pin 6″ and fixed with a single stud via the threaded bore 16. Compared to the exemplary embodiment shown in FIG. 1, this design saves the weight of the separate carrier plate 1′ and at least one screwed connection.

Given the exemplary embodiment of the bearing with the features of the invention shown in FIG. 2, a further addition compared to the bearing shown in FIG. 1 is provided insofar as a controllable regulating valve 30 is provided instead of the damping throttle nozzle 9. This enables an even more flexible and faster regulating response of the spring characteristics and absorber characteristics of the bearing compared to a regulation exclusively obtained by the compressed air at the air supply connection 8. In this way, not only is the primary, load-dependent regulation of the characteristics possible, but a multi-frequency tuning or adjustment is also possible to a great extent that is capable not only of optimizing load-alternation impacts but also to enable a dynamic reaction to changing operating conditions.

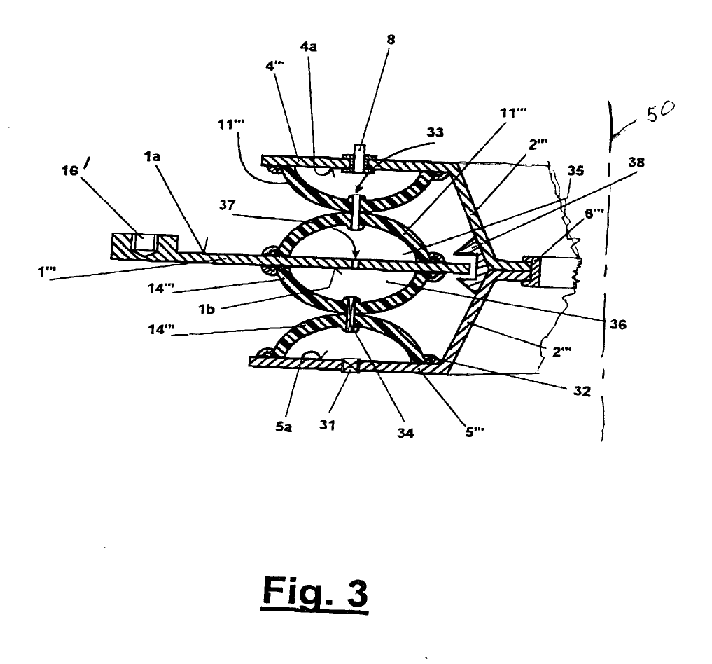

Given the exemplary embodiment shown in FIG. 3, the kinematics are reversed compared to the exemplary embodiments shown in FIGS. 1 and 2. The carrier plate 1′″ is arranged between a supporting plate or containing plate 4′″ and a counterplate or containing plate 5′″ in a freely-oscillatable fashion as a load connector piece. The load, for example a motor vehicle assembly, can be connected to the carrier plate 1′″ via a threaded bore 16′. The containing plates 4′″ and 5′″ are fashioned directly of and at a chassis carrier plate 2′″ by deformation. In contrast to the exemplary embodiment shown in FIGS. 1 and 2, the pneumatic chambers of the air bearing are not composed of self-contained hose rings but of elastomer profiles 11′″ and 14′″ that have flange-like, all-around outside edges 32. By these beaded edges 32, the elastomer profile members 11′″ and 14′″ are axially open surface-wide and are secured on the inside surfaces 4a, 5a of the containing plates 4′″ and 5′″ and, as likewise shown in FIG. 3, are also potentially secured on the surface 1a and 1b of the carrier plate 1′″. Such a fastening can occur by snapping pre-fabricated, complementary profiles, by gluing, by being vulcanized on or in some other way with or without additional clamping with shackles. What is decisive is that the pneumatic chambers formed in this way, for example the pneumatic chambers 35 and 36 shown at both sides of the carrier plate 1′″, are closed pneumatically tight and pressure-proof.

Given the exemplary embodiment shown in FIG. 3, the containing plates 4′″ and 5′″ are rigidly connected to one another by a clamping arrangement 6′″ and configured so stiff that, given use in conformity with the intent, they, themselves, cannot be excited to co-oscillate due to the oscillation of the carrier plate 1′″.

Given the exemplary embodiment shown in FIG. 3, additional air spring chambers 11′″ and absorber chambers 14′″ are designed and fashioned of air pillows, for example as spherical caps. With rotation of the illustrated system around an axis 50, which lies in the plane of the drawing to the right, an annular dynamically balanced bearing with annular plates 4′″ and 5′″ is obtained that comprises better stability for higher stresses. The air spring and air absorbers of the system can likewise be fashioned outwardly open around a central panel or radially inwardly open around a central opening.

Given the exemplary embodiment schematically shown here in FIG. 3, the two pneumatic chambers formed between the containing plate 4′″ and the surface la of the carrier plate 1′″ are configured as an air spring 11′″ that is correspondingly changed with the compressed air in a pressure range from 0.5 through 2 bar via a compressed air connection 8 and via a compressed air source (not shown in the Figures).

Whereas the pneumatic chamber 35 is fashioned with a relatively great pneumatic over-pressure and a resiliently stiff wall 11′″, the pneumatic chamber 36 serves as an absorber chamber. The two pneumatic chambers are connected to one another by a throttle opening 37 in the carrier plate 1′″.

The elastomer profiles 11′″-11′″ and 14′″-14′″ arranged at both sides of the carrier plate 1′″ respectively form an interconnected, pneumatically resilient system that is firmly joined to both convex outside surfaces and respectively connected to one another by pneumatic channels. In the exemplary embodiment shown in FIG. 3, these systems are connected, first, by means of a simple overflow channel 33 or, respectively, a pre-adjusted control valve 34. These two sub-systems are in communication with one another via a throttle opening 37 between the spring chamber and the absorber chamber. The damping behavior of the bearing can be regulated via a regulating valve 31 that controllably connects the absorber chamber formed on the inside surface 5a of the containing plate 5′″ to the ambient air, namely also dynamically controllable in conformity with the respective operating conditions. The overall behavior of the bearing shown in FIG. 3 that is oscillatable in a damped fashion can be tuned—use-variable as well—very precisely and without great outlay for even the most difficult areas of employment, both by means of the air pressure that is supplied and charges in a pre-stressing fashion as well as via the cross-sections and the loss behavior of the chamber connections up through the controllable settings of the regulating valve 31.

In a way that is finally indicated in FIG. 3 for the sake of completeness, the oscillatable carrier plate 1′″ here can be protected by a rubberized impact system 38 against an axial as well as against a radial over-shooting given excessively great amplitudes.

The air bearing, which is controllable in load-dependent fashion, particularly for automotive engineering, is, thus, fundamentally composed of a central abutment or center plate through which a freely movable rigid coupling pin passes axially and to which a support connector member is, in turn, rigidly connected at the support side and a counterplate is rigidly connected at the opposite side. An air spring hose ring that can be variably charged with compressed air is arranged between the support connector member and the abutment. At the opposite side of the central plate, an absorber hose ring is inserted between the central plate and the counterplate. The two hose ring systems are directly connected to one another via one or more throttle nozzles. The absorber hose comprises a nozzle or a regulating valve that opens the absorber hose ring to the ambient air or, in the case of the valve, can also close the absorber hose ring to the ambient air. Identical results can also be obtained with a bearing that likewise realizes a kinematic reversal of this basic structure in such a way that the axial carrier plate is configured as a load connection and freely oscillatable between the connecting plates.

Although various minor modifications may be suggested by those versed in the art, it should be understood that we wish to embody within the scope of the patent granted hereon all such modifications as reasonably and properly come within the scope of our contribution to the art.

I claim:

1. An air bearing comprising an axial central carrier plate, a support plate arranged on one side of the carrier plate and a counterplate being arranged on the opposite side of the carrier plate, means for rigidly connecting the support plate to the counterplate to hold them axially spaced apart, at least one elastic air spring member located between the carrier plate and the support plate, at least one elastic absorber member arranged between the carrier plate and the counterplate, a connector for an air supply hose being provided to the air spring member and at least one damping nozzle connecting the air spring member to the absorber member.

2. An air bearing according to claim 1, wherein a regulating means selected from a throttle nozzle, a control valve and a regulating valve connects the interior of the absorber member to the ambient air.

3. An air bearing according to claim 1, wherein the air supply connection is connected to a controllable air supply system.

4. An air bearing according to claim 1, wherein the elastic absorber member is a thin elastic compensation membrane connected to a surface of one of the central plate and the counterplate.

5. An air bearing according to claim 1, wherein the absorber member is a hose ring spring that is connected to means for adjusting the ring to match respective operating conditions.

6. An air bearing according to claim 1, wherein the air spring member is a hose ring spring member.

7. An air bearing according to claim 1, wherein the air spring member and the absorber member are hose ring springs having an outside hose profile deviating from the inside cross-sectional profile upon formation of the hose ring walls for setting anisotropic spring characteristics of the bearing.

8. An air bearing according to claim 1, wherein one of the air spring member and the absorber member is selected from an annular channel-shaped member axially open surface-wide on one side and a spherical cap-shaped elastomer profile member axially open surface-wide on one side, said member being fixed along the edges of the open side pneumatically tight and pressure-proof on one of said plates.

9. An air bearing according to claim 8, wherein at least one of the air spring member and the absorber member includes two elastomer profile members being joined together at the convex outer surfaces and a pneumatic connection passing through the convex surfaces to form an overflow channel, a throttle channel, a regulating valve or a control valve or combinations of these elements for the two members.

10. An air bearing according to claim 8, wherein the carrier plate has an opening to form a pneumatic connection of two pneumatic chambers lying opposite one another on two surfaces of the carrier plate.

11. An air bearing according to claim 1, wherein the bearing is used in automotive engineering and the central member is connected to a chassis of the vehicle.
